(19) United States
(12) Patent Application Publication
(10) Pub. No.: US 2014/0091921 A1
(43) Pub. Date: Apr. 3, 2014

(54) Lighting Apparatus with Functions of Break Warning and Directional Indication

(71) Applicant: PEI-HSUN CHENG, New Taipei City (TW)

(72) Inventor: PEI-HSUN CHENG, New Taipei City (TW)

(21) Appl. No.: 13/629,629

(22) Filed: Sep. 28, 2012

(51) Int. Cl. B60Q 1/44

(52) U.S. Cl. 340/479

(57) ABSTRACT

The present invention provides a lighting apparatus with functions of break warning and directional indication, comprising a break sensor unit, a control unit, at least one display unit and a direction sensor unit. The break sensor unit detects a reduced speed of a vehicle during its break and outputs a break signal correspondingly; the control unit is eclectically connected to the break sensor unit and outputs a break actuation signal correspondingly; the display unit is symmetrically provided on two lateral sides of the vehicle rear and displays different colors of warning lights based on the break actuation signal. The control unit is connected to a direction sensor unit for detecting a turning direction of the vehicle and outputting a direction signal such that the control unit outputs a direction actuation signal based on the direction signal and the display unit displays an indication light based on the direction actuation signal.

### TECHNICAL FIELD OF THE INVENTION

The present invention is related to a warning and indication light, in particular, to a lighting apparatus having functions of displaying the amount of break exerted on the vehicle and indicating the direction of the traveling vehicle.

### DESCRIPTION OF THE PRIOR ART

According to a vehicle research and data analysis, it is known that during the traveling of the vehicle at high speed, the rear driver is, on average, given only approximately two seconds of time to determine the break light indicated by the vehicle at the front; therefore, when the vehicle at the front decelerates rather rapidly during an emergency break, the rear vehicle is often forced to stop by break at a much shorter distance in order to keep the vehicle safe and the rear driver is also being given a much shorter reaction time to response to such emergency break. In other words, the faster the speed of the vehicle, the shorter the reaction time of the driver in response to maintain the safety of the vehicle during the break as well as the greater the length of distance of the vehicle required to maintain such vehicle safety during break.

In view of the above, it is clear that the rear vehicle driver often cannot immediately determine from the break light of conventional cars whether the front vehicle is undergoing a normal breaking or an emergency breaking, which becomes one of the primary causes of rear car colliding with the front car due to insufficient breaking distances and time of response and such that the lives of passengers and drivers are jeopardized. While realizing such drawbacks of the known break and with years of research and development in the field, the inventor provides the present invention in light of overcoming the drawbacks of the known arts.

### SUMMARY OF THE INVENTION

The present invention provides a lighting apparatus with functions of break warning and directional indication, comprising a break sensor unit, a control unit, at least one display unit and a direction sensor unit. The break sensor unit is provided for detecting a reduced speed of a vehicle during a break thereof and for outputting a break signal based on an amount of said reduced speed; the control unit is eclectically connected to the break sensor unit and is provided for outputting a break actuation signal based on said break signal; the at least one display unit is symmetrically provided on two lateral sides of a rear portion of said vehicle and electrically connected to the control unit, having a plurality of display colors; wherein the at least one display unit is activated by the break actuation signal outputted by the control unit and displays a plurality of different colors of warning lights based on a type of the break actuation signal.

The control unit further comprises a direction sensor unit electrically connected thereto such that when the control unit fails to detect the reduced speed the vehicle during the break thereof, the direction sensor unit detects a turning direction of the vehicle and outputs a direction signal based on the turning direction and such that the control unit further outputs a direction actuation signal based on the direction signal correspondingly, and the display unit is activated by the direction actuation signal outputted by the control unit to display an indication light based on a type of the direction actuation signal.

Preferably, the abovementioned plurality of different colors comprises green, purple and blue.

Preferably, the abovementioned amount of the reduced speed during the break comprises three levels of heavy break, medium break and light break; and wherein the heavy break corresponds to the color of green, the medium break corresponds to the color of purple and the light break corresponds to the color of blue respectively.

Preferably, the abovementioned display unit is secured onto a two lateral sides of a rear license plate of the vehicle via a connector attached thereon.

Preferably, the abovementioned display unit is mounted at spaces between two lateral sides of a rear license plate of the vehicle and turning lights thereof.

Preferably, the abovementioned display unit is mounted at two lateral sides of a rear license plate of the vehicle to replace turning lights thereof.

Preferably, the abovementioned display unit comprises a plurality of LED lights.

Preferably, the abovementioned display unit is a single LED light.

Preferably, the abovementioned display unit is a LED light with a directional indication.

In accordance with the abovementioned structural configurations, the lighting apparatus with functions of break warning and directional indication of the present invention is able to properly display a warning with the amount of the break of the travelling vehicle and to indicate the direction of the travelling vehicle such that the driving safety of rear cars can be enhanced to reduce traffic accidents while providing a design that is novel and of inventive step over the known arts.

### BRIEF DESCRIPTION OF THE DRAWINGS

FIG. 1 is a functional block diagram of the system configuration of the lighting apparatus of the present invention;

FIG. 2 is a first illustration showing the display unit of the lighting apparatus of the present invention;

FIG. 3 is a second illustration showing the display unit of the lighting apparatus of the present invention;

FIG. 4 is a third illustration showing the display unit of the lighting apparatus of the present invention;

FIG. 5 is a relevant table showing the correspondence of the lighting apparatus of the present invention;

FIG. 6 is a first illustration showing the attachment of the display unit of the lighting apparatus of the present invention on a vehicle;

FIG. 7 is a second illustration showing the attachment of the display unit of the lighting apparatus of the present invention on a vehicle; and

FIG. 8 is a third illustration showing the attachment of the display unit of the lighting apparatus of the present invention on a vehicle.

### DETAILED DESCRIPTION OF THE PREFERRED EMBODIMENTS

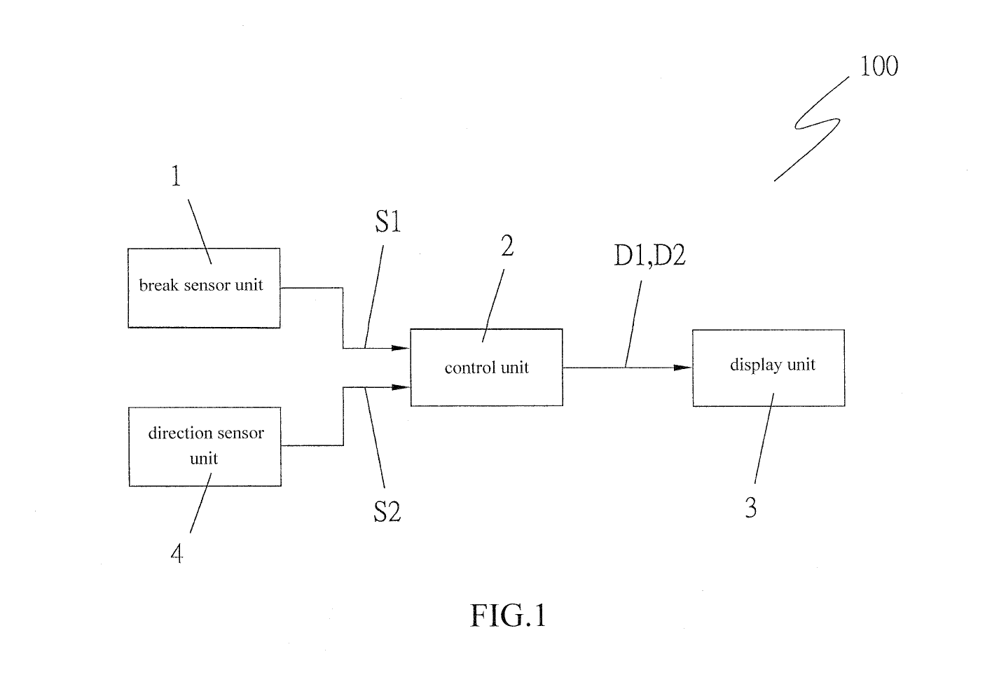

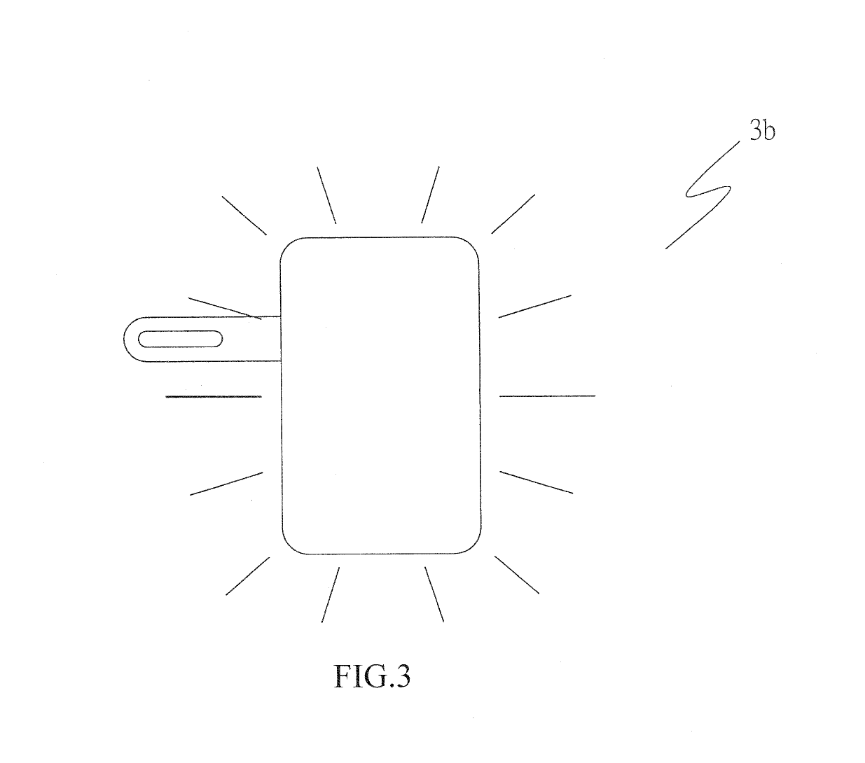

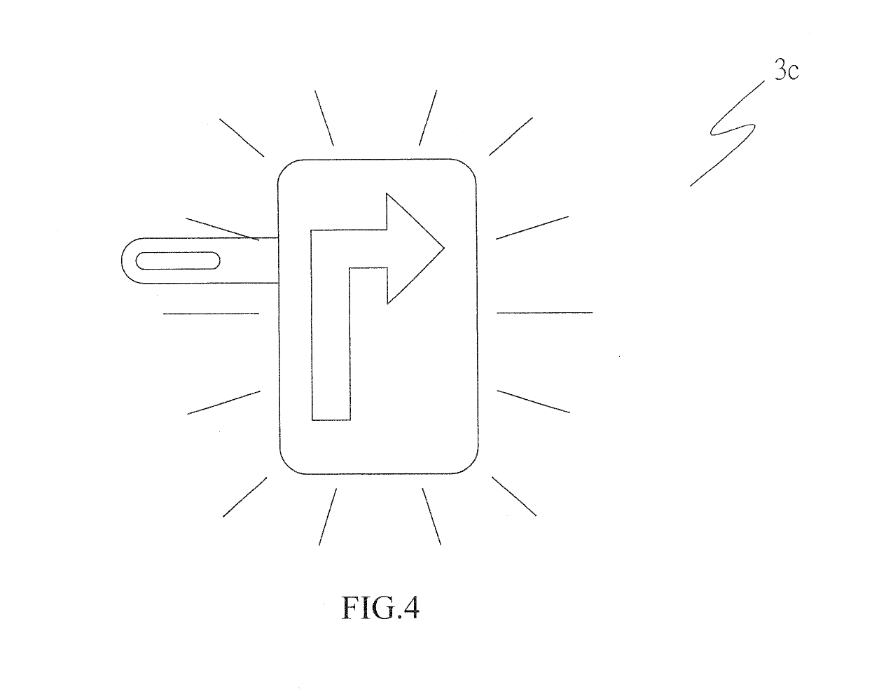

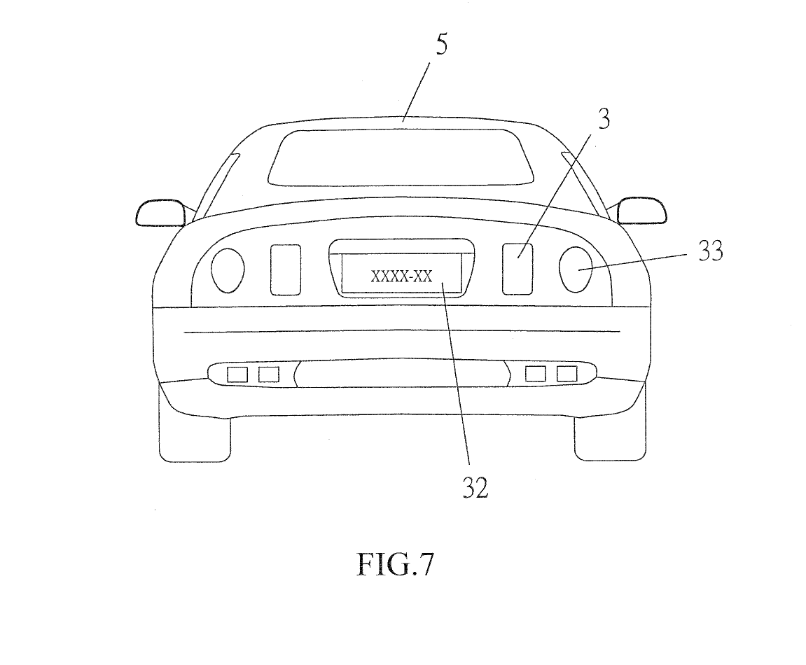

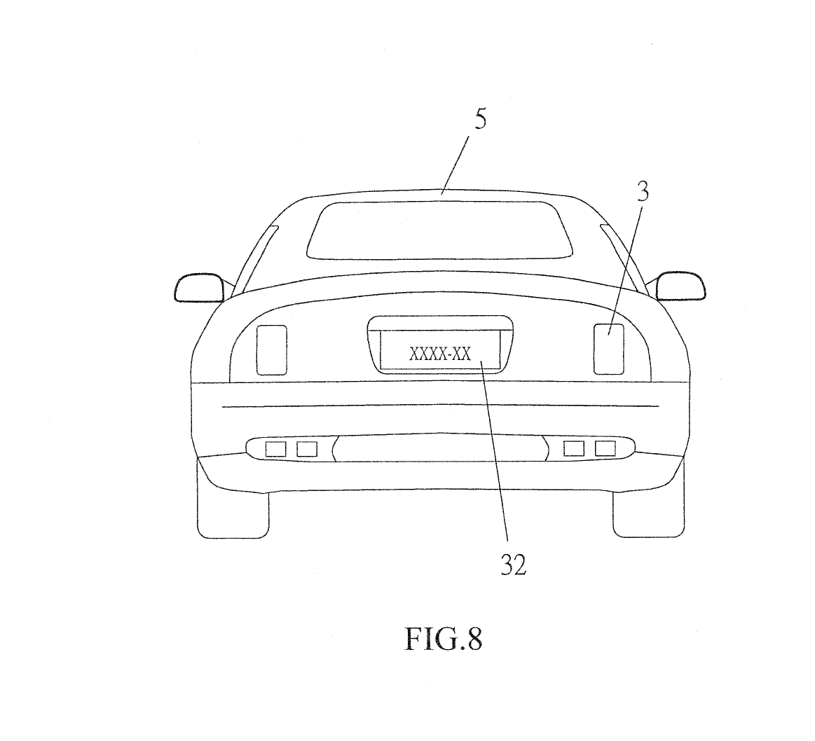

As shown in FIGS. 1 to 8, the present invention provides a lighting apparatus 100 with functions of break warning and directional indication, comprising a break sensor unit 1, a control unit 2, at least one display unit 3 and a direction sensor unit 4. The break sensor unit 1 is provided for detecting a reduced speed of a vehicle 5 during a break thereof and for outputting a break signal S1 based on an amount of said reduced speed. The control unit 2 is eclectically connected to the break sensor unit 1 and is provided for outputting a break actuation signal D1 based on said break signal S1. The at least one display unit 3 is symmetrically provided on two lateral sides of a rear portion of said vehicle 5 and electrically connected to the control unit 1, having a plurality of display colors; wherein the at least one display unit 3 is activated by the break actuation signal D1 outputted by the control unit 2 and displays a plurality of different colors of warning lights based on a type of the break actuation signal D1.

The control unit 2 further comprises a direction sensor unit 4 electrically connected thereto such that when the control unit 2 fails to detect the reduced speed of the vehicle 5 during the break thereof, the direction sensor unit 4 detects a turning direction of the vehicle 5 and outputs a direction signal S2 based on the turning direction and such that the control unit 2 further outputs a direction actuation signal D2 based on the direction signal S2 correspondingly, and the display unit 3 is activated by the direction actuation signal D2 outputted by the control unit 2 to display an indication light based on a type of the direction actuation signal D2.

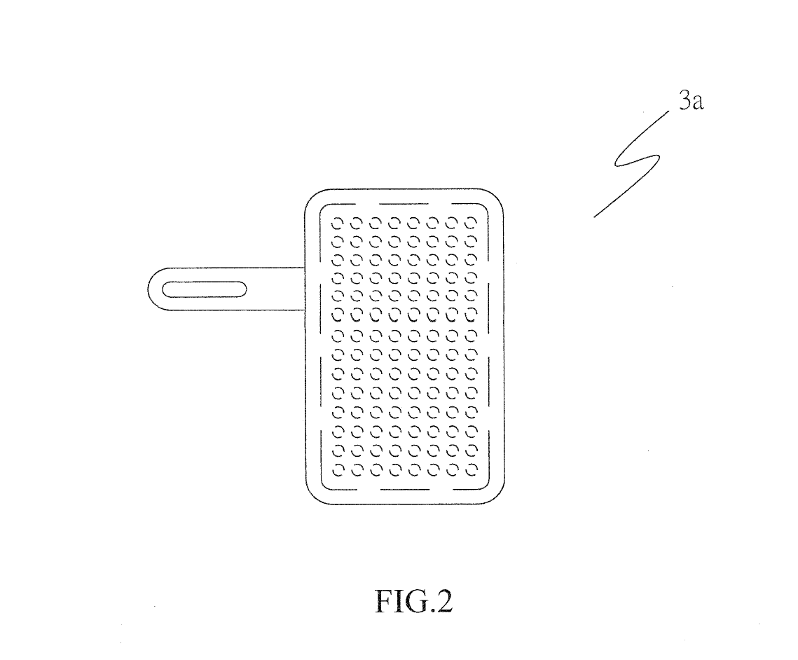

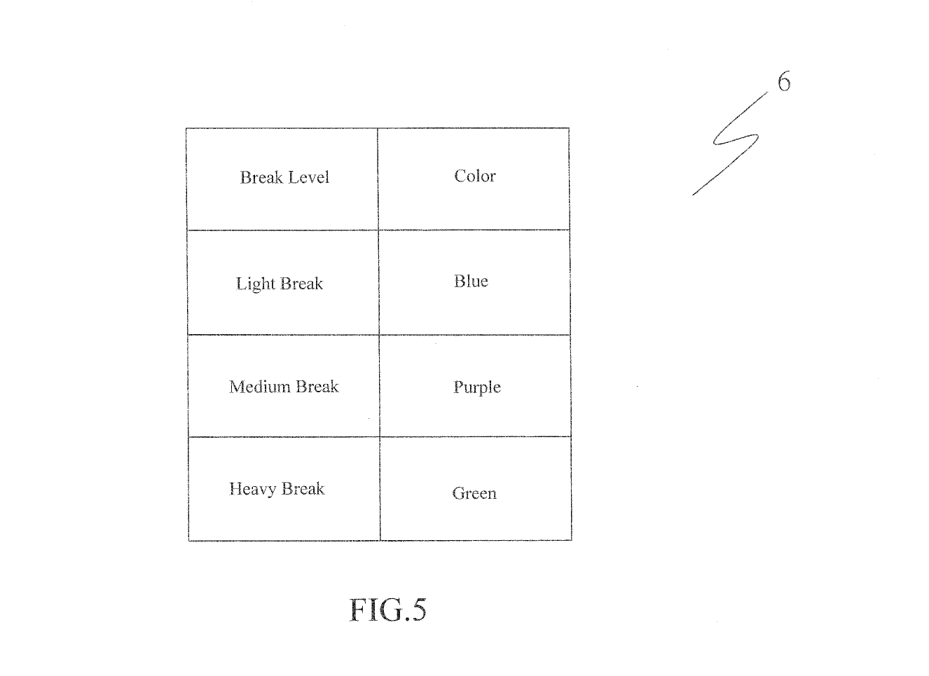

As shown in FIGS. 2 to 4, the display unit 3a is a single LED light; whereas the display unit 3b comprises a plurality of LED lights; and whereas the display unit 3c is a LED light with a directional indication. FIG. 5 shows a relevant table showing the correspondence between the displayed colors and the amount of break of the vehicle. As shown in FIG. 5, the plurality of different colors of display including green, purple and blue correspond to different amounts of the reduced speed of the vehicle during the break including three levels of breaks of heavy break, medium break and light break; and wherein the heavy break corresponds to the color of green, the medium break corresponds to the color of purple and the light break corresponds to the color of blue respectively.

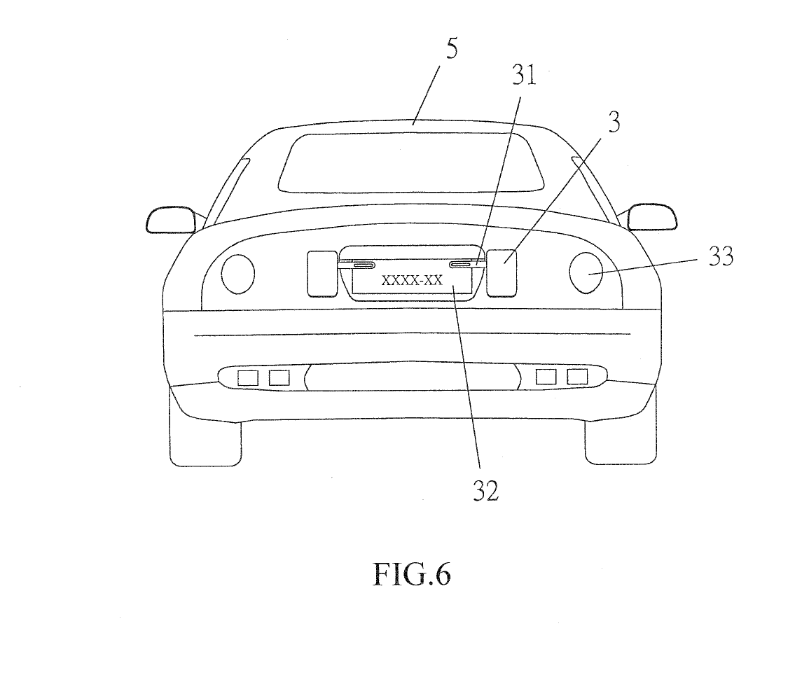

As shown in FIGS. 6 to 8, the display unit 3 can be secured onto two lateral sides of a rear license plate 32 of the vehicle 5 via a connector 31 attached thereon. In another exemplary embodiment of the installation of the present invention, the display unit 3 can be mounted at spaces between two lateral sides of a rear license plate 32 of the vehicle and turning lights 33 thereof. In still another exemplary embodiment of the installation of the present invention, the display unit 3 can be mounted at two lateral sides of a rear license plate 32 of the vehicle to replace turning lights 33 thereof.

What is claimed is:

1. A lighting apparatus with functions of break warning and directional indication, comprising:
a break sensor unit for detecting a reduced speed of a vehicle during a break thereof and for outputting a break signal based on an amount of said reduced speed;
a control unit, eclectically connected to said break sensor unit, for outputting a break actuation signal based on said break signal;
at least one display unit, symmetrically provided on two lateral sides of a rear portion of said vehicle and electrically connected to said control unit, having a plurality of display colors; wherein said at least one display unit is activated by said break actuation signal outputted by said control unit and displays a plurality of different colors of warning lights based on a type of said break actuation signal.

2. The lighting apparatus with functions of break warning and directional indication according to claim 1, wherein said control unit further comprises a direction sensor unit electrically connected thereto such that when said control unit fails to detect said reduced speed said vehicle during the break thereof, said direction sensor unit detects a turning direction of said vehicle and outputs a direction signal based on said turning direction and such that said control unit further outputs a direction actuation signal based on said direction signal correspondingly, and said display unit is activated by said direction actuation signal outputted by said control unit to display an indication light based on a type of said direction actuation signal.

3. The lighting apparatus with functions of break warning and directional indication according to claim 1, wherein said plurality of different colors comprises green, purple and blue, and wherein said amount of said reduced speed during the break comprises three levels of heavy break, medium break and light break; and wherein said heavy break corresponds to said color of green, said medium break corresponds to said color of purple and said light break corresponds to said color of blue respectively.

4. The lighting apparatus with functions of break warning and directional indication according to claim 1, wherein said display unit is secured onto two lateral sides of a rear license plate of said vehicle via a connector attached thereon.

5. The lighting apparatus with functions of break warning and directional indication according to claim 1, wherein said display unit is mounted at spaces between two lateral sides of a rear license plate of said vehicle and turning lights 33 thereof.

6. The lighting apparatus with functions of break warning and directional indication according to claim 1, wherein said display unit is mounted at two lateral sides of a rear license plate of said vehicle to replace turning lights 33 thereof.

7. The lighting apparatus with functions of break warning and directional indication according to claim 1, wherein said display unit comprises a plurality of LED lights.

8. The lighting apparatus with functions of break warning and directional indication according to claim 1, wherein said display unit is a single LED light.

9. The lighting apparatus with functions of break warning and directional indication according to claim 1, wherein said display unit is a LED light with a directional indication.
